(19) United States
(12) Patent Application Publication
(10) Pub. No.: US 2026/0050419 A1
(43) Pub. Date: Feb. 19, 2026

(54) Visual Programming System for Composing Mixed-Reality Interactions between Real and Virtual Objects and Integrating User Safety Protocol Against Harmful Interactions with Real Objects in Mixed-Reality Environment

(71) Applicant: DoubleMe, Inc, Seoul (KR)

(72) Inventor: Heekwan Kim, Seoul (KR)

(21) Appl. No.: 19/299,837

(22) Filed: Aug. 14, 2025

Related U.S. Application Data
(60) Provisional application No. 63/684,316, filed on Aug. 16, 2024.
(60) Provisional application No. 63/684,320, filed on Aug. 16, 2024.

(51) Int. Cl. G06F 8/34; G06T 19/00; G06V 20/20

(52) U.S. Cl. CPC G06F 8/34; G06T 19/006; G06V 20/20; G06T 2200/24; G06T 2219/024

(57) ABSTRACT

A novel visual programming system for composing mixed-reality (MR) interactions among users, real objects, and virtual objects is disclosed. This novel programming system utilizes an intuitive three-dimensional (3D) visualization interface for composition of mixed-reality (MR) experiences. The 3D visualization interface in programming of various MR contents reduces the barrier of entry to MR content creations by making specialized software coding knowledge unnecessary to content creators, unlike the conventional MR programming tools. The novel visual programming system uniquely incorporates a spatial anchoring method for tying both virtual and real objects to a physical location intended to be used as an MR environment in order to provide a visualized, intuitive, and seamless programming capability across both virtual and real objects in the MR environment. The novel visual programming system also uniquely incorporates user safety protocols to prevent injuries or harm arising from potentially-dangerous interactions between MR users and real objects.

### INCORPORATION BY REFERENCE

A US provisional patent application, US63/684,316, titled “Visual Programming System for Authoring Mixed Reality Interactions with Real and Virtual Objects,” and filed on Aug. 16, 2024, is incorporated herein by reference. The present invention also claims benefit to the US provisional application of US63/684,316.

Furthermore, a US provisional patent application, US63/684,320, titled “Real-Time Object Recognition and Integration for Mixed Reality Programming,” and filed on Aug. 16, 2024, is incorporated herein by reference. The present invention also claims benefit to the US provisional application of US63/684,320.

### BACKGROUND OF THE INVENTION

The present invention generally relates to the field of mixed-reality (MR) systems and programming interfaces. More specifically, the present invention relates to a visual programming system for composing and choreographing interactions between virtual elements and real (i.e., physical) objects in mixed-reality environments that can be visualized with a head-mounted display device or another mixed-reality visualization electronic device. Furthermore, the present invention also relates to proactively incorporating user safety protocols in mixed-reality (MR) interaction compositions to prevent accidents or potentially unsafe interactions between real objects and users in an MR environment.

Moreover, the present invention also relates to immersive mixed-reality visualization of real (i.e., physical) and virtual (i.e., holographic) elements in a designated real physical space. In addition, the present invention relates to an immersive computer-synthesized visualization environment for composing and choreographing interactions between real and virtual objects without requiring software coding or programming knowledge to a mixed-reality (MR) content creator.

Virtual reality (VR) and augmented reality (AR) applications are gaining increasing popularity and relevance in electronic user applications. For example, VR headsets for computers and portable devices are able to provide interactive and stereoscopic gaming experiences, training simulations, and educational environments for users wearing the VR headsets. In another example, augmented reality (AR) mobile applications are designed to add texts, descriptions, or added (i.e., “augmented”) digitized materials to physical objects if a user wears AR goggles or utilizes AR-compatible mobile applications executed in portable devices. For one of ordinary skill in the art, virtual reality (VR) refers to a completely computer-generated synthetic environment with no direct correlations to a real physical space or a real physical object, while augmented reality (AR) refers to descriptive digital materials that are displayed next to a machine-recognized real physical object to add or “augment” more information to the physical reality.

However, conventional VR and AR applications are unable to provide seamless integration of ultra-high resolution and lifelike holographic three-dimensional (i.e., “virtual”) objects juxtaposed to real physical objects located in a particular physical location for interactive and immersive curation with both synthetic and real objects, because the conventional VR applications merely provide user interactions in a purely computer-generated synthetic (i.e. virtual) environment with no correlation to physical objects in a real physical space, while the conventional AR applications merely provide additional informational overlays (i.e., information augmentation) to machine-recognized real physical objects via partially-transparent AR goggles or AR-enabled camera applications in mobile devices.

A recent evolution of conventional VR and AR applications has resulted in an innovative intermixture of computer-generated lifelike holographic objects and real objects that are synchronized and correlated to a particular physical space (i.e. as a “mixed-reality” (MR) environment) for immersive user interactions during the user's visit to the particular physical space. Unfortunately, conventional tools used in creating mixed-reality (MR) contents generally require significant knowledge of programming and software coding and are legacy VR/AR composition products. The required technical knowledge for software coding serves as a barrier against MR content compositions by non-technical members of the creative community. Furthermore, the conventional legacy VR/AR content creation tools make coordinating and choreographing interactions between virtual holographic objects and real (i.e., physical) objects in a particular physical space arduous and tricky, even for those trained in such conventional VR/AR content creation tools.

A first category of the conventional legacy VR/AR creation tools includes traditional programming frameworks for VR/AR (e.g., Unity3D with ARFoundation, Unreal Engine with AR support, Apple's ARKit and Google's ARCore), which require substantial coding knowledge and do not provide intuitive visual interfaces for connecting real and virtual elements. A second category of the conventional legacy VR/AR creation tools includes visual programming tools for 3D environments (e.g., Unreal Engine Blueprints, Unity Visual Scripting (formerly Bolt)), which offer some visual programming capabilities for computer graphics-generated virtual objects and virtual environments, but sorely lack any robust coordination and integration with real (i.e., physical) objects.

Furthermore, a third category of the conventional legacy AR/VR creation tools includes immersive authoring tools (e.g., Google's Tilt Brush, Oculus Medium), which focus on three-dimensional (3D) content creation within purely synthetic virtual reality (VR) environments, but do not address the programming of interactions, especially with real (i.e., physical) objects located in a designated physical space and defined by physical real-world coordinates. Lastly, Internet of Things (IoT) programming platforms (e.g., Node-RED, IFTTT (If This Then That)) offer some visual programming capabilities for IoT devices, but these tools are not designed for spatial computing, let alone complex mixed-reality (MR) environments that require seamless correlation and choreographic interaction designs between virtual and real objects.

Moreover, the conventional VR/AR and IoT content creation tools have not anticipated inherent dangers of a mixed-reality (MR) environment, which embodies a potential user safety risk with a real-world physical object that is integrated in the MR content. For example, a user immersed in the MR environment may accidentally collide with a physical object, or gets harmed by the dangerous nature (e.g., an industrial machinery, a heavy or sharp object, a sensitive animal, etc.) of the physical object, if the MR content creator does not proactively incorporate safety provisions when designing the boundaries of possible interactions between the user and the physical object present in the MR environment. The existing tools in the industry today have not empowered MR content creators to define or design safety provisions or boundaries for deterring potentially-dangerous interactions between users and real physical objects in the mixed-reality (MR) environments composed by the MR content creators.

Therefore, it may be beneficial to devise a novel visual programming system for composing and choreographing mixed-reality (MR) interactions between virtual elements and real (i.e., physical) objects, wherein the novel visual programming system does not require technical software coding knowledge or expertise for an MR content creator.

Furthermore, it may also be beneficial to devise a novel visual programming system that provides visually-intuitive integration between virtual and real elements for incorporating seamless interactions between the virtual and real elements during an MR content synthesis, instead of treating such elements separately, as in the case with existing legacy AR/VR programming tools.

In addition, it may also be beneficial to devise a novel visual programming system that empowers a mixed-reality (MR) content creator to integrate robust and proactive user safety protocols, at the interaction design stage of an MR content, to prevent accidents or potentially-harmful interactions between a user immersed in the MR content and a physical object incorporated in the MR content.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In a preferred embodiment of the invention, a visual programming system for composing mixed-reality (MR) interactions between real objects and virtual objects and integrating a user safety protocol against harmful interactions is disclosed. This visual programming system comprises: (1) a head-mounted display device integrating a camera or another portable electronic device integrating the camera, wherein the head-mounted display device or the another portable electronic device is configured to communicate multimedia information with other parts of the visual programming system; (2) an object recognition module configured to scan, identify, and track a real physical object in a physical space, which is intended to be utilized as a mixed-reality (MR) environment, wherein the object recognition module is able to scan the real physical object via the multimedia information captured and transmitted by the camera integrated in the head-mounted display device or the another portable electronic device; (3) a visual programming core configured to generate a visual programming interface that represents the real physical object scanned by the object recognition module as a new real object node, and the real objects and the virtual objects already present in the MR environment as interconnectable nodes, wherein the new real object node and the interconnectable nodes are manipulated and controlled by a mixed-reality (MR) content creator to compose the MR interactions among various real and virtual objects and prospective users of the MR environment; (4) an event and signal processing engine configured to manage dataflows and events among the new real object node and the interconnectable nodes; (5) a spatial mapping and anchoring system configured to map the physical space to generate the mixed-reality (MR) environment and tie the various real and virtual objects together to the MR environment in a singular and unified coordinate system; (6) a safety protocol engine configured to empower the MR content creator to synthesize the user safety protocol that defines interactive limits and boundaries in the MR interactions between the prospective users and the real physical object to prevent user injuries or other harmful interactions when the prospective users are immersed in the MR environment; and (7) a memory unit and at least one of a central processing unit (CPU), an application processing unit (APU), and a graphical processing unit (GPU) of a computer server or another computing device executing the object recognition module, the visual programming core, the event and signal processing engine, the spatial mapping and anchoring system, and the safety protocol engine, wherein the computer server or the another computing device is also operatively connected to the head-mounted display device integrating the camera or the another portable electronic device integrating the camera for data communication.

### BRIEF DESCRIPTION OF DRAWINGS

FIG. 1 shows a high-level system architecture diagram of a novel visual programming system for composing mixed-reality (MR) interactions, in accordance with an embodiment of the invention.

FIG. 2 shows a content creator's view through a mixed-reality headset executing the visual programming interface generated by the novel visual programming system, in accordance with an embodiment of the invention.

FIG. 3 is a flowchart depicting the process of recognizing and integrating real-world physical objects into the visual programming environment, in accordance with an embodiment of the invention.

FIG. 4 shows an example of the node-based visual programming interface, including virtual and real object nodes, action nodes, and their connections, in accordance with an embodiment of the invention.

FIG. 5 shows a spatial anchoring method of the novel visual programming system that ties programming elements to specific locations in a physical environment, in accordance with an embodiment of the invention.

FIG. 6 shows a sequence diagram for an event and signal processing flow between connected nodes, in accordance with an embodiment of the invention.

FIG. 7 shows a user interface for creating and managing abstracted components in the visual programming environment that enables an encapsulated modularization of complex interactions for a convenient reuse.

FIG. 8 shows a screenshot of a real-time preview and debugging interface from the visual programming environment that demonstrates how users can test and refine their mixed-reality (MR) interactions.

FIG. 9 shows a safety protocol interface flowchart in the visual programming environment of the novel visual programming system, wherein the safety protocol interface empowers a mixed-reality (MR) content creator to prevent or deter potentially-harmful or unsafe interactions between a user and a real-world physical object, in accordance with an embodiment of the invention.

FIG. 10 shows an export and deployment interface in the visual programming environment of the novel visual programming system, illustrating how MR experiential contents synthesized by an MR content creator can be saved, shared, and deployed across various MR user engagement platforms from the novel visual programming system, in accordance with an embodiment of the invention.

FIG. 11 is a use case diagram depicting various applications of the novel visual programming system in different domains such as education, smart homes, and interactive art installations, in accordance with an embodiment of the invention.

FIG. 12 shows a comparative diagram illustrating direct correlations between a visual programming representation and a resulting mixed-reality (MR) user experience for a complex MR interaction, in accordance with an embodiment of the invention.

FIG. 13 shows a comparative diagram demonstrating a conventional workflow for creating an MR interaction and a new workflow for creating the same MR interaction using the novel visual programming system as embodied in the present invention.

FIG. 14 shows object recognition capabilities of the novel visual programming system as embodied in the present invention, which is configured to seamlessly identify and integrate various real-world (i.e., physical) objects into the visual programming environment of the novel visual programming system.

FIG. 15 shows a user interaction diagram to demonstrate how users can manipulate and connect virtual and real elements within the visual programming interface of the novel visual programming system.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of description of shapes, configurations, and/or other symbolic representations that directly or indirectly resemble one or more electronic systems and methods for visual programming and composition (i.e., “authoring”) of mixed-reality (MR) interactions between real and virtual objects and integrating user safety protocols against harmful interactions with real objects in MR environments. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order and do not imply any limitations in the invention.

One objective of an embodiment of the present invention is to devise a novel visual programming system for composing and choreographing mixed-reality (MR) interactions between virtual elements and real (i.e., physical) objects, wherein the novel visual programming system does not require technical software coding knowledge or expertise for an MR content creator.

In addition, another objective of an embodiment of the present invention is to devise a novel visual programming system that provides visually-intuitive integration between virtual and real elements for incorporating seamless interactions between the virtual and real elements during an MR content synthesis, instead of treating such elements separately, as in the case with existing legacy AR/VR programming tools.

Furthermore, another objective of an embodiment of the present invention is to devise a novel visual programming system that empowers a mixed-reality (MR) content creator to integrate robust and proactive user safety protocols, at the interaction design stage of an MR content, to prevent accidents or potentially-harmful interactions between a user immersed in the MR content and a physical object incorporated in the MR content.

Moreover, another objective of an embodiment of the present invention is to provide a method of operating the novel visual programming system that accommodates composing and choreographing of mixed-reality (MR) interactions between virtual elements and real (i.e., physical) objects.

For the purpose of describing the invention, a term referred to as “mixed reality,” or “MR,” as an acronym, is defined as an intermixture of computer-generated lifelike holographic (i.e., “virtual) objects and physical (i.e., “real”) objects that are synchronized and correlated to a particular physical space for immersive user interactions during the user's visit to the particular physical space. When experiencing a mixed-reality environment, the user is able to visualize holographic virtual objects that are computer graphics-generated and physical objects in the particular physical space simultaneously through an electronic visualization device. Typically, unlike conventional augmented reality applications, the computer-generated lifelike holographic objects are ultra high-resolution (e.g. 4K/UHD) or high-resolution (e.g. HD quality or above) three-dimensional synthetic objects that are intermixed and/or juxtaposed to real physical objects, wherein a viewer immersed in the mixed-reality environment is often unable to distinguish the synthetic nature of the computer-generated lifelike holographic objects and the real physical objects provided by the mixed-reality environment. The viewer immersed in the mixed-reality environment is typically required to be present at the particular physical space correlated and synchronized with the computer-generated lifelike holographic objects and the real physical objects in one or more mixed-reality artificial layers superimposed on the particular physical space. Furthermore, in a preferred embodiment of the invention, the viewer is also required to wear a head-mounted display (HMD) device or at least utilize a mobile electronic device configured to execute a mixed-reality mobile application, in order to experience the mixed-reality environment.

Furthermore, for the purpose of describing the invention, a term referred to as a “mixed-reality (MR) content creator” is defined as a mixed-reality (MR) user experience designer, or a mixed-reality (MR) user interaction choreography designer, who creates, defines, and plans potential interactions and/or related choreographic interactive sequences among a mixed-reality (MR) environment user, virtual holographic object(s), and real physical object(s) that are correlated to a particular physical space. In a preferred embodiment of the invention, by utilizing robust and proactive user safety protocols integrated into the novel visual programming system, the MR content creator is also able to incorporate, at the outset of the interaction design stage of the MR content, some critical safety boundaries to prevent or deter potentially-dangerous interactions between an MR user and at least some real physical objects, which may pose health or physical injury risks to the MR user without proactive safety provisions at the interaction design stage.

In addition, for the purpose of describing the invention, a term referred to as a “mixed-reality artificial layer” is defined as a computer-generated graphics layer in which mixed-reality objects (MROs) and mixed-reality holographic human figures are configured to be created and positioned by the novel visual programming system onto virtual coordinates, which correlate to a particular physical space currently occupied by an mixed-reality (MR) user.

Moreover, for the purpose of describing the invention, a term referred to as “hologram” is defined as a three-dimensional holographic object configured to be displayed from a head-mounted display (HMD) device, a mobile device executing a mixed-reality visual mobile application, or another electronic device with a visual display unit. Typically, a hologram is capable of being animated as a three-dimensional element over a defined period of time. Examples of holograms utilized mixed-reality environments composed, synthesized, or revised by the novel visual programming system include, but are not limited to, a humanized holographic figure designed to interact with a mixed-reality (MR) user, or a mixed-reality virtual object, which can be intermixed with or juxtaposed to physical (i.e., real) objects for seamlessly-vivid visualizations of both artificial holograms (i.e., as virtual objects) and physical objects at a particular physical space currently occupied by the MR user.

In addition, for the purpose of describing the invention, a term referred to as “three-dimensional model,” or “3D model,” is defined as one or more computer-generated three-dimensional images, videos, or holograms. In a preferred embodiment of the invention, a computerized 3D model is created as a hologram after multi-angle video data are extracted, transformed, and reconstructed by three-dimensional graphics processing algorithms executed in a computer system or in a cloud computing resource comprising a plurality of networked and parallel-processing computer systems. The computer-generated 3D model can then be utilized as a mixed-reality object (MRO) or a humanized mixed-reality hologram (MRH) in a mixed-reality artificial layer superimposed on a particular physical space correlated by virtual coordinates from the novel visual programming system.

Moreover, for the purpose of describing the invention, a term referred to as “cloud” is defined as a scalable data network-connected and/or parallel-processing environment for complex graphics computations, transformations, and processing. The data network-connected and/or parallel-processing environment can be provided using a physical connection, a wireless connection, or both. For example, a cloud computing resource comprising a first cloud computing server, a second cloud computing server, and/or any additional number of cloud computing servers can each extract and transform a portion of multi-angle video data simultaneously as part of a scalable parallel processing algorithm, which performs temporal, spatial, and photometrical calibrations, and executes depth map computation, voxel grid reconstruction, and deformed mesh generation. A scalable number of cloud computing servers enables a real-time or near real-time transformation and reconstruction of 3D models after video recording devices transmit multi-angle video data to the cloud computing resource.

Although various legacy and conventional programming tools that were originally developed for augmented reality (AR) or virtual reality (VR) content creation are able to accommodate mixed-reality (MR) content creation and authoring in a limited capacity, there are several serious disadvantages with the conventional AR/VR programming and creation tools to simply repurpose its use in the mixed-reality (MR) content creation. For example, the conventional legacy AR/VR tools lack seamless and intuitive integration of virtual and real elements interactions and choreography planning at the outset of an MR content design. The conventional legacy AR/VR tools often treat virtual and real-world elements separately, which makes creations of seamless interactivity designs between them for MR users cumbersome and difficult.

Furthermore, the conventional legacy AR/VR programming and creation tools also present a high barrier of entry against aspiring MR content creators who may not be technically trained in software engineering, because the legacy tools require significant and extensive software coding knowledge. In addition, the conventional legacy AR/VR tools merely offer limited real-time feedback to content creators and generally do not provide immediate in-situ feedback during authoring (i.e., element-to-user, user-to-element, and element-to-element interaction designing, experience planning, content creation, etc.) of MR experiences by a content creator, which makes the content authoring process laborious, time-consuming, and error-prone.

Moreover, the conventional legacy AR/VR programming and creation tools lack robust mechanisms for creating an abstraction of components that can encapsulate complex MR interactions for easy reuse in other situations. In addition, the conventional legacy AR/VR programming and creation tools have inadequate user safety considerations, and do not incorporate built-in safety protocols for user interactions with real-world physical objects in an MR environment, which could result in harmful accidents, injuries, or even deaths.

Furthermore, the conventional legacy AR/VR programming and creation tools lack spatial (i.e., three-dimensional) programming interfaces and are still based on two-dimensional interfaces, which make a visual depth-based (i.e. a Z-axis) mixed-reality environment difficult to correlate to an MR content creator. In addition, the conventional legacy AR/VR programming and creation tools provide limited or insufficient support for dynamic object recognition and integration, and typically rely on pre-defined object databases and lack the ability to dynamically recognize and integrate new real-world objects into the programming environment.

In contrast, the novel visual programming system in accordance with one or more embodiments of the present invention uniquely provides a more intuitive, seamless, and efficient mixed-reality (MR) interaction authoring platform that effectively blends virtual and physical elements in a safe and reusable manner, with a novel built-in user interaction safety protocol and a layer of abstraction that can encapsulate a complex chain of mixed-reality (MR) interactions as a reusable “abstracted”component.

The novel visual programming system for composing and choreographing interactions between virtual elements and real objects in mixed-reality (MR) environments, in accordance with a preferred embodiment of the invention, expands the mixed-reality (MR) content creator base to include non-technical yet motivated content writers to create, plan, and direct a complex set of mixed-reality applications by visually connecting virtual and real-world elements in the programming interface itself. The lowered barrier of entry for the MR content creator base enables democratization of MR content creation, bridges the gap between the digital and the physical worlds, and promotes diverse and intuitive creation of interactive MR experiences.

The novel visual programming system is designed to be used with mixed-reality (MR) hardware, such as head-mounted displays (HMDs) or smart glasses, in conjunction with cameras and sensors for real-world object recognition. It can be applied in various domains, including but not limited to: (1) education and training; (2) industrial design and prototyping; (3) smart home and office automation; (4) interactive art installations; (5) accessibility applications; (6) gaming and entertainment; and (7) retail and marketing experiences. By providing a user-friendly interface for creating mixed-reality interactions, the novel visual programming system aims to democratize MR development and enable a wider range of users to harness the power of spatial computing and object-aware environments.

In a preferred embodiment of the invention, the novel visual programming system operates by allowing content creators to visually construct mixed-reality (MR) interactions within the mixed reality environment itself. The content creators can drag-and-drop virtual (i.e., holographic) objects, select recognized real-world (i.e., physical) objects, and draw connections between them to define behaviors. For example, a content creator can create a virtual switch that, when activated, turns on a physical lamp in the room.

Furthermore, a visual programming interface provided by the novel visual programming system uses a node-based user interface, wherein each node represents a virtual or real object, an action, or a data source. Lines connecting these nodes represent dataflows or events. The node-based intuitive interface accommodates convenient creations of complex behaviors without necessitating traditional coding or software coding knowledge. Importantly, by providing a unified environment for authoring interactions between virtual and physical elements, the novel visual programming system significantly simplifies the process of creating mixed-reality experiences and contents. With an easy-to-use visualization-based content programming environment, the novel visual programming system opens up new possibilities for rapid prototyping, interactive design, and smart environment generation while maintaining a focus on user safety and interface accessibility in the mixed-reality environment.

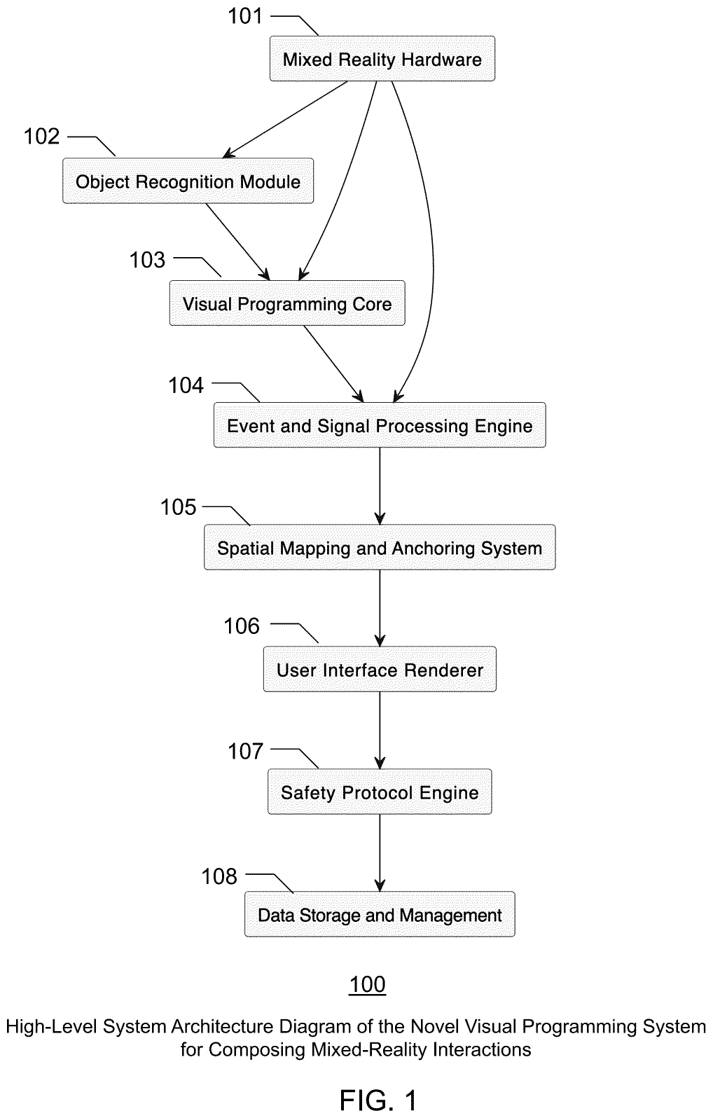

FIG. 1 shows a high-level system architecture diagram (100) of a novel visual programming system for composing mixed-reality (MR) interactions, in accordance with an embodiment of the invention. As illustrated in the high-level system architecture diagram (100) in FIG. 1, the novel visual programming system comprises the following components: mixed-reality hardware equipment (101), an object recognition module (102), a visual programming core (103), an event and signal processing engine (104), a spatial mapping and anchoring system (105), a user interface renderer (106), a safety protocol engine (107), and a data storage and management unit (108).

In the preferred embodiment of the invention, the mixed-reality (MR) hardware equipment (101) is one or more electronic devices specialized in recording, sensing, and/or visualizing an MR environment during or after an MR content composition by a content creator. Examples of the MR hardware equipment that can be suitable as hardware components of the novel visual programming system include, but are not limited to, mixed-reality (MR) headsets or head-mounted devices (HMDs), such as Microsoft HoloLens, Magic Leap, or smartphone-based augmented-reality visualization devices that incorporate cameras and sensors for environmental and object tracking.

The MR hardware equipment (101) in the novel visual programming system is configured to capture, sense, and transmit environmental and physical object information from its cameras and sensors to the object recognition module (102), as shown in FIG. 1. The object recognition module (102) then utilizes computer vision algorithms and machine-learning models to identify and track real-world objects in real time from the environmental and physical object information captured and transmitted by the MR hardware equipment (101). In the preferred embodiment of the invention, the object recognition module (102) utilizes computer vision algorithms to identify and track real-world objects and empower an MR content creator to utilize the digitized representations of the real-world objects during his or her MR content and interaction development from the novel visual programming interface.

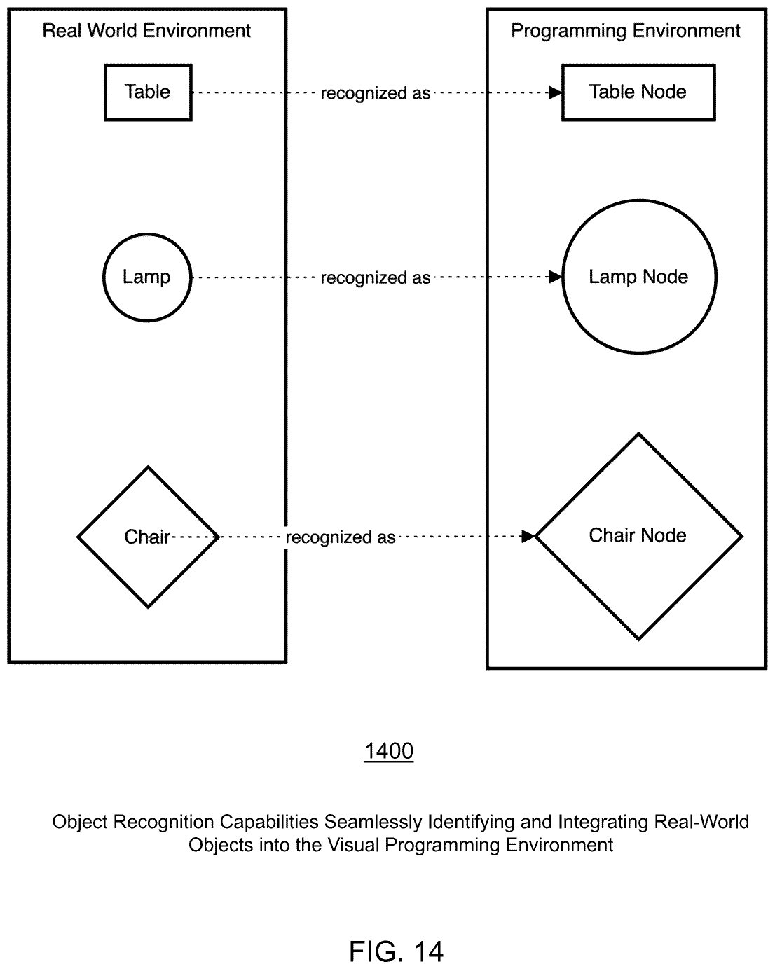

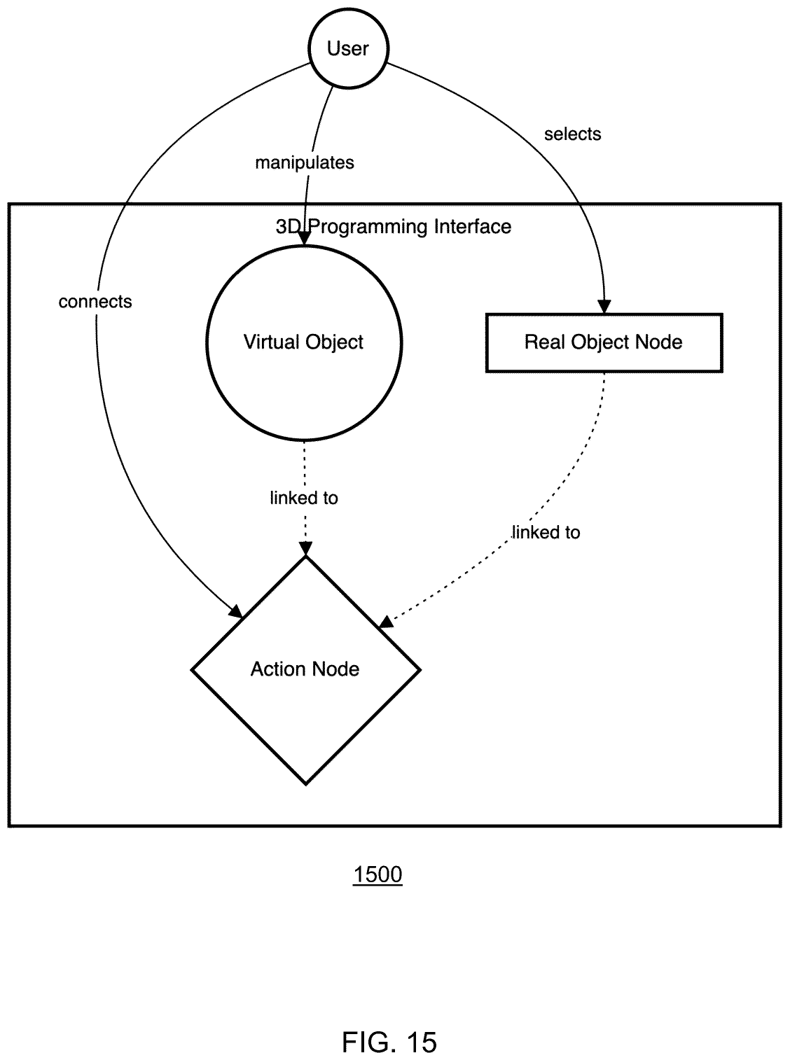

The novel visual programming system for composing mixed-reality (MR) interactions also includes the visual programming core (103), which is responsible for generating and managing a node-based visual programming interface and processing user inputs. In the preferred embodiment of the invention, the node-based visual programming interface generated by the visual programming core (103) is a three-dimensional (3D) and spatially-aware interface in which a content creator (i.e., an MR experienced designer) can create and manipulate (e.g., connect, disconnect, rewire, etc.) nodes representing both virtual and real elements. The node-based visual programming interface, which is generated by the visual programming core (103), enables seamless interaction designs between virtual and real objects in a particular physical space as visualized graphical elements within the programming interface itself, instead of requiring more specialized software coding knowledge during an MR content creation. The novel aspect of the node-based programming interface is further illustrated in FIG. 4, FIG. 14, and FIG. 15, and are elaborated in the corresponding detailed description.

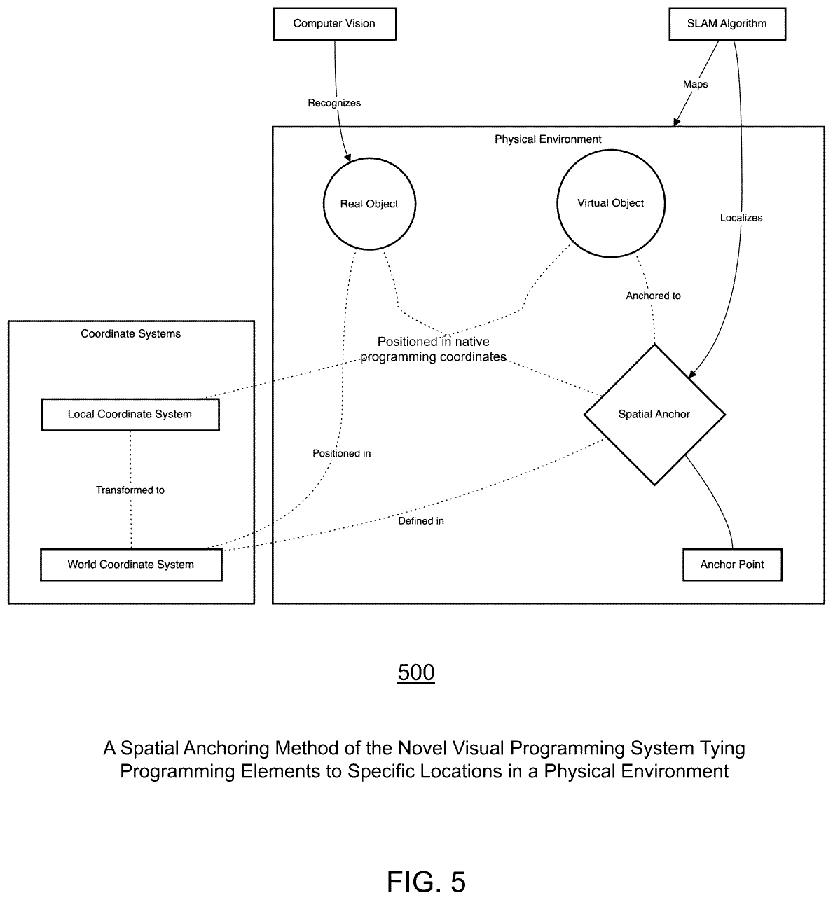

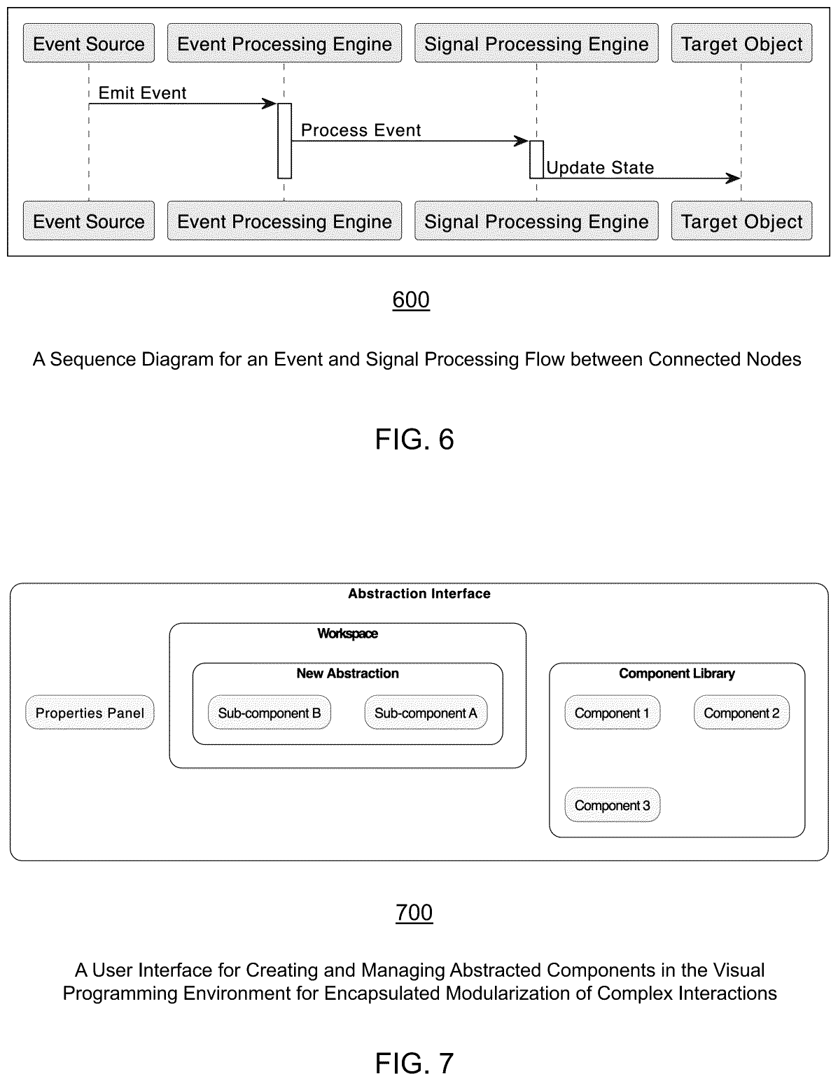

Continuing with the high-level system architecture diagram (100) of FIG. 1, the novel visual programming system for composing mixed-reality (MR) interactions also includes the event and signal processing engine (104), which is configured to handle dataflow and events between connected nodes in the programming interface. The event and signal processing concepts, in context of the novel visual programming system, are further illustrated in FIG. 6 and elaborated in the corresponding detailed description. The novel visual programming system also incorporates the spatial mapping and anchoring system (105), which is configured to map the physical environment and allow virtual objects/elements to be anchored to a particular physical space planned for generating an MR environment and executing a corresponding MR content. The novel aspects of the spatial-anchoring mechanism involving a spatial anchor and virtual object(s) in a seamless coordinate compatibility with real physical object(s) in a physical environment are further illustrated in FIG. 5 and elaborated in the corresponding detailed description.

Moreover, as shown in FIG. 1, the novel visual programming system for composing mixed-reality (MR) interactions also includes the user interface renderer (106), which is configured to generate three-dimensional (3D) user interface elements that are visible to a content creator or a user in an MR environment executing an MR content. In addition, the novel visual programming system also includes the safety protocol engine (107), which implements and enforces safety provisions and rules to prevent and/or deter accidents, injuries, or other harmful consequences to a user interacting with real (i.e., physical) objects in an MR environment created by a content creator through the visual programming system of the present invention. The safety protocol engine (107) empowers the content creator to generate or synthesize a user safety protocol that defines interactive limits and boundaries in the MR interactions between the prospective users and the real objects in the MR environment to prevent user injuries or other harmful interactions, when the prospective users are immersed in the MR environment.

Furthermore, as shown in the high-level system architecture diagram (100) in FIG. 1, the novel visual programming system also includes the data storage and management unit (108) that handles saving, loading, and managing created mixed-reality (MR) experiences and abstracted components generated through an abstraction interface (i.e., FIG. 7), wherein the abstracted components are configured to be utilized in multiple MR content creation activities as “drag-and-droppable” reusable modular software components by the content creator using the visual programming system.

In the preferred embodiment of the invention, the object recognition module (102), the visual programming core (103), the event and signal processing engine (104), the spatial mapping and anchoring system (105), the user interface renderer (106), the safety protocol engine (107), and the data storage and management unit (108) of the novel visual programming system are software components that are executed in a central processing unit (CPU), an application processing unit (APU), a graphical processing unit (GPU), and/or a memory unit of a computer server or another computing device. The computer server or another computing device that executes these software components are also operatively connected to the mixed-reality (MR) hardware equipment (101) (e.g., a head-mounted display (HMD) device incorporating a camera, position sensors, accelerometers, etc.) for data communication of captured, recorded, and/or displayed information associated with real physical objects, virtual holographic objects, and a physical environment used to generate a mixed-reality (MR) content and an associated MR environment.

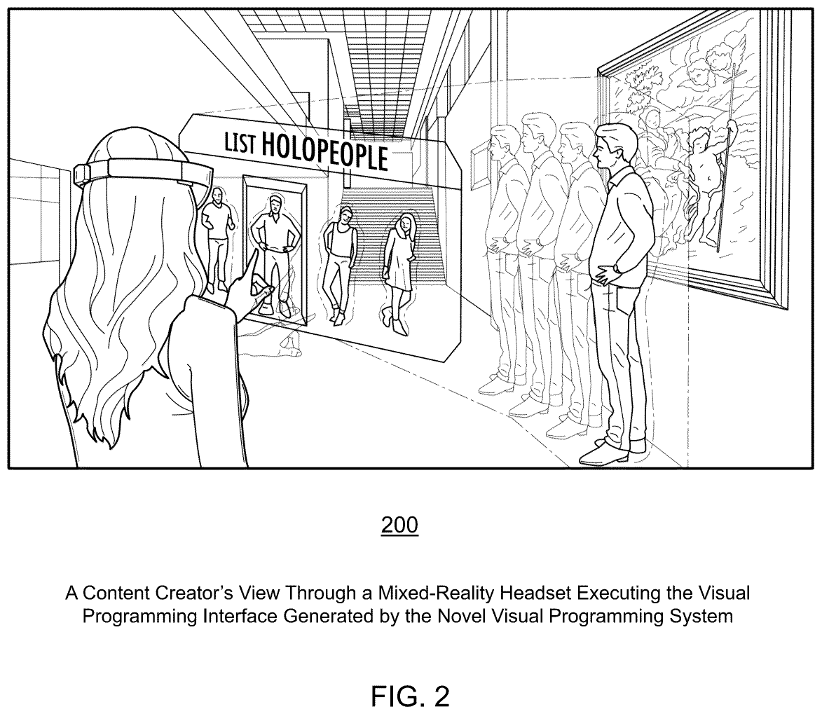

FIG. 2 shows a content creator's view through a mixed-reality headset executing a visual programming interface (200) generated by the novel visual programming system, in accordance with an embodiment of the invention. As illustrated in FIG. 2, the visual programming interface (200) generated by the novel visual programming system is an immersive three-dimensional (3D) visual programming interface perceived through the mixed-reality headset that enables the content creator to compose, select, or edit interaction designs among real physical and virtual holographic elements in the immersive 3D mixed-reality visualization environment.

In the example as shown in FIG. 2, the content creator (e.g., a mixed-reality experience designer) places holographic contents and overlays user interaction elements in the desired spot within the 3D map by utilizing the visual programming interface (200) generated by the novel visual programming system. In this particular example, the content creator is placing a holographic museum curator in front of an exhibited painting and choreographing the holographic museum curator's movements, actions, and/or narrations, so that the future mixed-reality users to this physical space (i.e., the museum) can experience the holographic museum curator's interactivities in front of the exhibited painting, if the MR user is immersed the MR environment visualized through an HMD device or another portable electronic device enabling the MR environment.

In some embodiments of the invention, the holographic virtual objects, such as the holographic museum curator as shown in FIG. 2, may integrate artificial intelligence to answer questions and/or converse dynamically and informatively, if the MR user is to ask questions to the holographic virtual objects while utilizing their HMD devices or other mixed-reality environment-enabling portable electronic devices. Furthermore, the holographic virtual objects and/or contents placed in the desired spot and the overlayered user interaction elements can be time-sequenced and choreographed relative to potential user interactions with the holographic and/or physical objects, which can be experienced in the desired spot through an immersive mixed-reality graphics environment provided by HMD devices or other portable electronic devices utilized by MR users, when the fully-constructed MR experience event is activated in the desired spot.

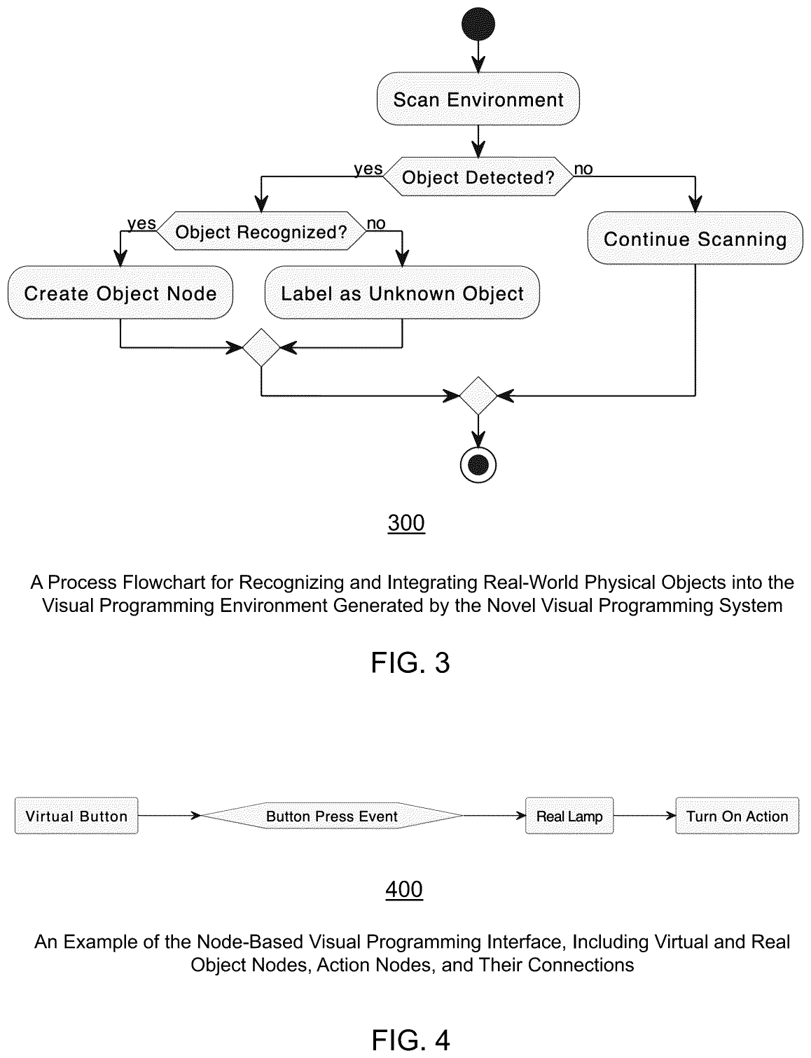

FIG. 3 is a flowchart (300) depicting the process of recognizing and integrating real-world physical objects into the visual programming environment through the object recognition module of the novel visual programming system, in accordance with an embodiment of the invention. As previously described in conjunction with FIG. 1, the object recognition module (i.e. 102 in FIG. 1) in the novel visual programming system is configured to detect physical objects in a particular physical space intended for a mixed-reality (MR) interaction and create “object nodes” for physical (i.e., real) objects that can be seamlessly and digitally integrated by the novel visual programming system for interaction designs among real objects, virtual objects, and MR users.

In the preferred embodiment of the invention, the object recognition module employs a combination of edge-based detection, feature matching, and deep learning-based classification to identify real-world objects. As illustrated in the flowchart (300) in FIG. 3, this process involves the steps of: (1) continuously scanning a physical space intended to be utilized as a mixed-reality (MR) environment using camera(s) and/or sensors attached to a head-mounted MR device or another electronic device; (2) if an object is detected, pre-processing captured images to enhance features and reduce noise; (3) executing an object detection algorithms to identify potential objects of interest ; (4) categorizing and classifying detected objects using pre-trained machine learning models; (5) tracking recognized objects in 3D space using simultaneous localization and mapping (SLAM) techniques; and (6) representing each recognized object as an object “node” created in the visual programming interface, wherein the object node incorporates properties and potential interactions based on its identified type.

FIG. 4 shows an example (400) of the node-based visual programming interface, including virtual and real object nodes, action nodes, and their connections, in accordance with an embodiment of the invention. The node-based visual programming interface, which is generated by the novel visual programming system of the present invention, has several types of nodes as disclosed below:
(a) Object Nodes: represent both virtual and real (i.e., physical) objects.
(b) Action Nodes: represent actions that can be performed (e.g., “rotate”, “scale”, “turn on”).
(c) Event Nodes: represent system or user-generated events (e.g., “button press”, “collision”).
(d) Data Nodes: represent data sources or constants.
(e) Logic Nodes: represent logical operations (e.g., “if-then”, “loop”).

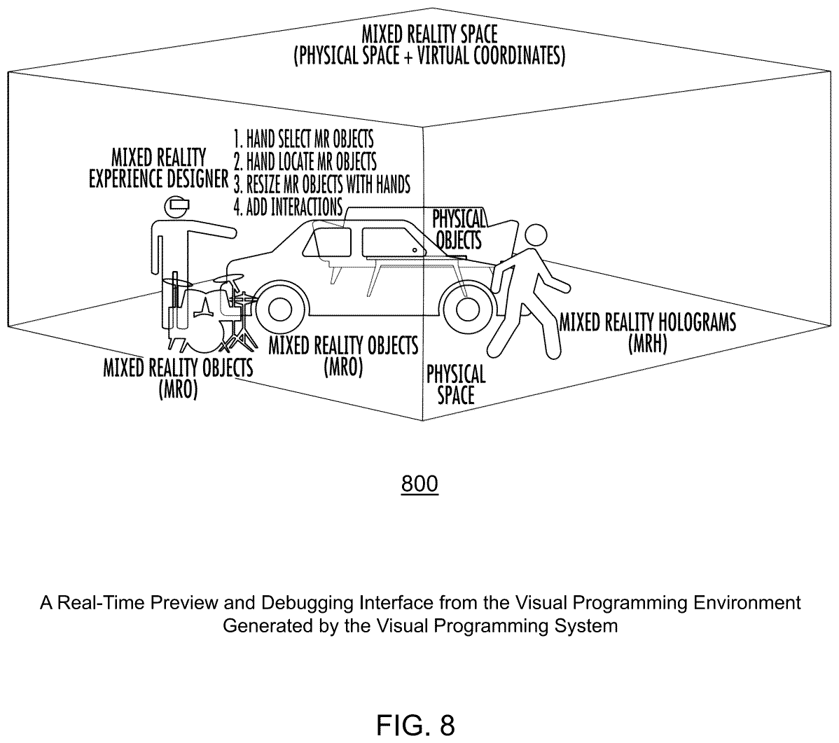

Furthermore, in the preferred embodiment of the invention, as illustrated in FIG. 4, FIG. 14, and FIG. 15, for example, connections between nodes are represented by lines to indicate the flow of data or events. The node-based connections in the visual programming interface enable users to draw lines between nodes to establish relationships and define interactions between elements and/or objects. Mixed-reality experience designers (i.e., content creators) can create these connections by drawing lines between node ports using mixed-reality controllers or gesture-based inputs while being immersed in a three-dimensional visual programming interface, as illustrated in the examples in FIG. 2 and FIG. 8.

In case of the example (400) in FIG. 4, the node-based visual programming interface incorporates a virtual button node (i.e., a virtual object node) that connects to a “button press” event node, which is connected to a real lamp (i.e., a real object node). As shown in the example (400) in FIG. 4, this real object node representing the real lamp is connected to a “turn on” action node. This chain of nodes and the connections between the nodes are configured to be created or manipulated (e.g., connect, disconnect, rewire, etc.) by a mixed-reality experience designer utilizing the node-based visual programming interface to define a series of potential interactions among mixed-reality (MR) users and real and virtual objects operating in an MR environment.

FIG. 5 shows a spatial anchoring method (500) of the novel visual programming system that ties programming elements to specific locations in a physical environment, in accordance with an embodiment of the invention. The spatial anchoring method (500) allows programming elements to be tied to specific locations in the physical environment. The spatial anchoring method (500) is provided by the spatial mapping and anchoring system (i.e., 105 in FIG. 1) within the visual programming system. As illustrated by FIG. 5, the spatial anchoring method (500) provides a seamless and unifying position coordinates between real objects and virtual objects by utilizing a spatial anchor that enables virtual objects originally defined in native programming system (i.e., local) coordinates to be fully translated to a world coordinate system, which defines the positions of the real objects relative to an actual physical space intended to provide a mixed-reality (MR) visualization environment.

Therefore, as shown in FIG. 5, the spatial mapping and anchoring system (i.e., 105 in FIG. 1) of the novel visual programming system, recognizes real physical objects in the actual physical space via computer vision, and the current position of each recognized real object is categorized and entered into the world coordinate system, while also being linked to the spatial anchor for real-time tracking of the future position of each recognized real object. Furthermore, the spatial mapping and anchoring system (i.e., 105 in FIG. 1) of the novel visual programming system executes simultaneous localization and mapping (SLAM) algorithms and techniques to generate a digital map of the structure of the actual physical space intended for the MR visualization environment, as also illustrated in FIG. 5. This digital map of the structure and related position coordinates, preferably standardized to the world coordinate system, are then entered into the spatial anchor for real-time position tracking of virtual and real objects in context of the physical space intended for the MR visualization environment.

Moreover, as also shown in FIG. 5, the virtual holographic objects created from the novel visual programming system by an MR content creator are initially defined in the native programming system (i.e., local) coordinates, which are subsequently translated into and transformed to the world coordinate system that defines the positions of real objects and the structure of the physical space intended for the MR visualization environment. In addition, each virtual object is dynamically linked, or “anchored”, to the spatial anchor, which keeps track of current and future position changes of virtual objects and real objects within the physical space, in real time. Typically, the real-time position tracking of various objects and elements by the spatial anchor is executed in a singular and unified coordinate system, such as the world coordinate system, as depicted in the spatial anchoring method (500) in FIG. 5. In the preferred embodiment of the invention, the spatial anchor has a defined anchor point within the physical space intended for the MR visualization environment. Importantly, the spatial anchor, provided by the spatial mapping and anchoring system (i.e., 105 in FIG. 1) within the visual programming system, serves as a unified and coherent real-time position-tracking platform for various real physical objects, holographic virtual objects, and physical structures in the MR visualization environment.

FIG. 6 shows a sequence diagram (600) for an event and signal processing flow between connected nodes, in accordance with an embodiment of the invention. As previously illustrated in FIG. 1, the visual programming system incorporates the event and signal processing engine (i.e., 104 in FIG. 1), which is able to handle dataflow and events between connected nodes in the programming interface. The event and signal processing engine enables real-time responses to user actions and environmental changes. In the preferred embodiment of the invention, the event and signal processing engine is configured to differentiate between discrete events (i.e., represented by event streams) and continuous data (i.e., represented by signals). Typically, event streams represent discrete occurrences, such as button presses or object collisions, while signals represent continuous data, such as object position, rotation, or scalar values.

As shown in the sequence diagram (600) in FIG. 6, an event source emits a request associated with an event, and this request is executed by the event and signal processing engine (i.e., 104 in FIG. 1), as shown in FIG. 6. Once the request associated with the event is fully processed and/or fulfilled, the event and signal processing engine (i.e., 104 in FIG. 1) updates the newly-changed state from the completed request associated with the event as a confirmatory signal, which is transmitted to the target object, as demonstrated in the sequence diagram (600) in FIG. 6 for the event and signal processing flow between the connected nodes. The differentiated handling of events and signals, as disclosed in the preferred embodiment of the invention, enables more precise controls over dataflows through the visual programming system and responses to the differentiated types of inputs.

FIG. 7 shows a user interface (700) for creating and managing abstracted components in the visual programming environment that enables an encapsulated modularization of complex interactions for a convenient reuse. The abstracted components in the visual programming environment are provided by the novel visual programming system, and enable mixed-reality (MR) experience designers (i.e., content creators) to group complex interactions into reusable (i.e., “abstracted”) components, thereby simplifying and shortening development time and effort for sophisticated MR content creations. In context of the user interface example in FIG. 7, each of the abstracted components (i.e., “Sub-component A” and “Sub-component B” in “New Abstraction” under “Workspace”, and three components in the “Component Library”) in the abstraction user interface (700) is an encapsulated modularization of complex interactions for a convenient reuse. Furthermore, each of the abstracted components is packaged and configured to be utilized in multiple MR content creation activities as a “drag-and-droppable” reusable modular software component that can be accessed and imported by content creators using the novel visual programming system.

FIG. 8 shows a screenshot (800) of a real-time preview and debugging interface from the visual programming environment that demonstrates how users can test and refine their mixed-reality (MR) interactions. The real-time preview and debugging interface is configured to provide immediate feedback on programmed interactions within the MR environment. As illustrated in the screenshot (800) in FIG. 8, the MR experience designer can place virtual elements, such as mixed-reality objects (MROs) and/or mixed-reality holograms (MRHs), and implement choreographic user interactivity elements, artificial intelligence for dynamic conversation capabilities associated with MROs or MRHs, and descriptive information that can be presented by the MROs or MRHs. Furthermore, the MR experience designer can also construct potential interactive possibilities among MROs, MRHs, physical objects, and prospective MR users.

From the real-time preview and debugging interface, the MR experience designer can select, direct, and/or place mixed-reality objects (MROs) and interactions in the MR artificial layer(s) intertwined with physical objects and physical space. In some embodiments, the MR experience designer can also utilize gesture commands, voice commands, or other action-invoking commands to select, locate, resize, and modify MROs and their choreographic user interactivity elements, using the real-time preview and debugging interface displayed through a mixed-reality head-mounted display (HMD) or another portable electronic device. By utilizing the real-time preview and debugging interface that provides an immersive 3D visualization of interactive virtual and physical objects and a particular physical space that houses the MR environment, the MR experience designer is able to readily preview and debug his or her MR content design and interactive boundaries among various virtual and real objects, especially in context of the particular physical space that embodies the MR environment.

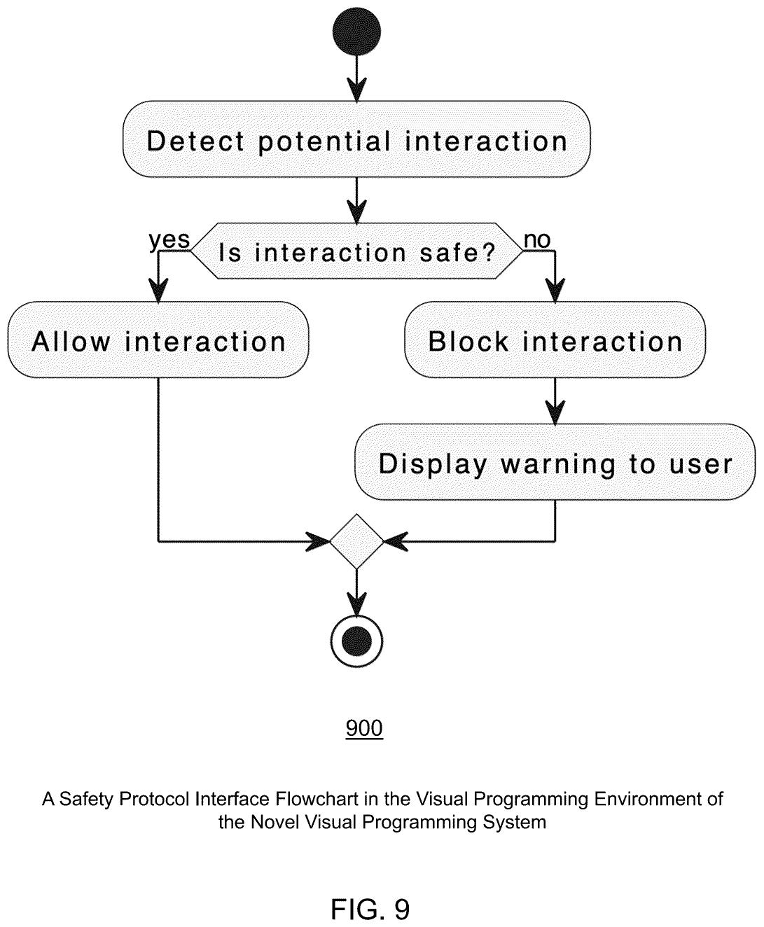

FIG. 9 shows a safety protocol interface flowchart (900) in the visual programming environment of the novel visual programming system, wherein the safety protocol interface empowers a mixed-reality (MR) content creator to prevent or deter potentially-harmful or unsafe interactions between a user and a real-world physical object, in accordance with an embodiment of the invention. As previously described in conjunction with FIG. 1, the safety protocol engine (i.e., 107 in FIG. 1) in the novel visual programming system implements checks and balances to prevent potentially-harmful and/or dangerous interactions between real physical objects and users immersed in a mixed-reality (MR) environment. In particular, the safety protocol engine empowers the content creator to generate or synthesize a user safety protocol that defines interactive limits and boundaries in the MR interactions between the prospective users and the real objects in the MR environment to prevent user injuries or other harmful interactions, when the prospective users are immersed in the MR environment

In the preferred embodiment of the invention, the safety protocol engine (i.e., 107 in FIG. 1) incorporates and enforces safety provisions and rules to prevent and/or deter accidents, injuries, or other harmful consequences to a user interacting with real (i.e., physical) objects in an MR environment created by a content creator through the novel visual programming system of the present invention. In context of the safety protocol interface flowchart (900) as illustrated in FIG. 9, the safety protocol engine is configured to detect or predict potential interaction between a physical object and an MR user, and then determines whether this potential interaction is safe to the MR user. If the potential interaction is determined or predicted to be safe by the safety protocol engine, then the novel visual programming system allows the potential interaction between the physical object and the MR user. In contrast, if the potential interaction is determined or predicted to be unsafe by the safety protocol engine, then the novel visual programming system blocks the potential interaction and displays safety warning to the content creator at the MR environment development stage, or to the MR user during his or her immersive participation in the MR content.

It is important to note that without the uniquely-novel safety protocol engine and the corresponding safety protocol interface flowchart (900) built into the novel visual programming system, a user immersed in the MR environment may accidentally collide with a physical object, or get harmed by the dangerous nature (e.g., an industrial machinery, a heavy or sharp object, a sensitive animal, etc.) of the physical object, if the MR content creator does not proactively incorporate safety provisions when designing the boundaries of possible interactions between the user and the physical object present in the MR environment. Therefore, the safety protocol interface of the novel visual programming system improves user safety in potentially-injurious or harmful situations involving various physical objects present in the MR environment by preemptively provisioning safety boundaries at the MR experience design stages by content creators.

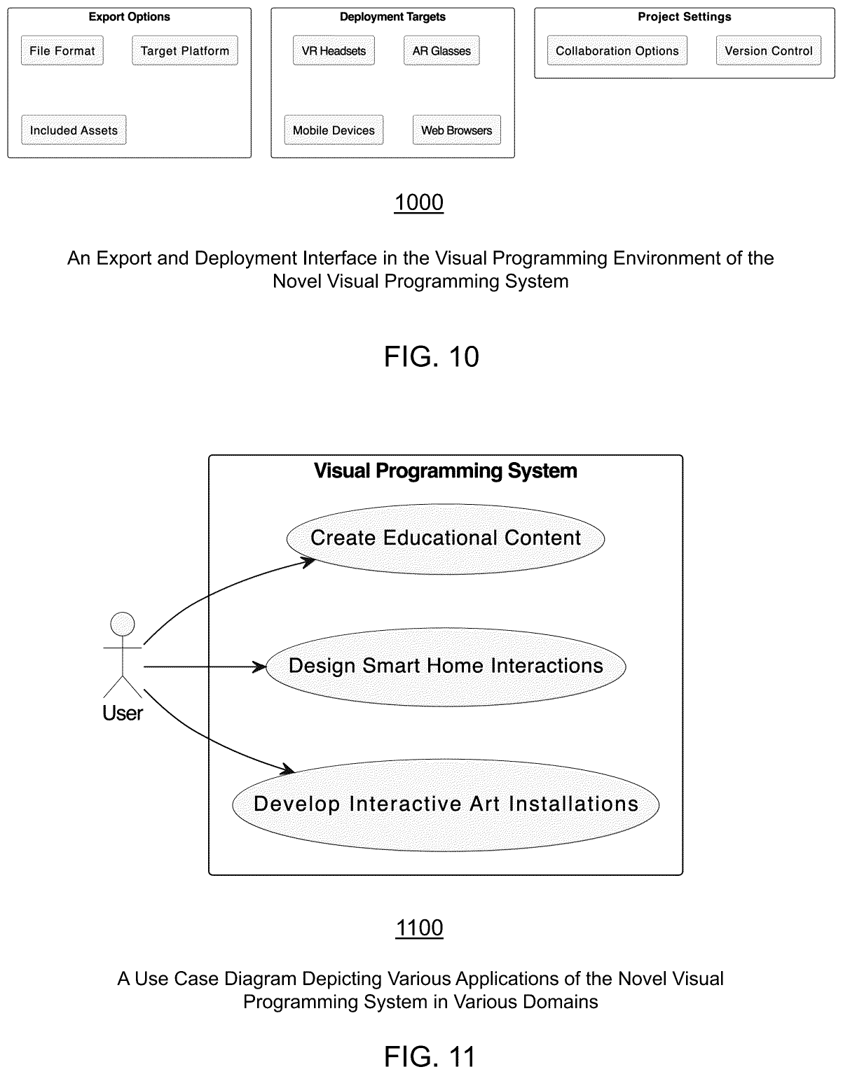

FIG. 10 shows an export and deployment interface (1000) in the visual programming environment of the novel visual programming system, in accordance with an embodiment of the invention. The export and deployment interface (1000) demonstrates how MR experiential contents synthesized by an MR content creator can be saved, shared, and deployed across various MR user engagement platforms from the novel visual programming system.

As illustrated in FIG. 10, the export and deployment interface (1000) includes an “export options” section comprising “file format”, “target platform”, and “included assets”. The export options section enables the MR content creator to specify file formats for the export, assets to include for the export, and targeted and/or destination platforms for the export. Furthermore, the export and deployment interface (1000) also includes a “deployment targets” section comprising various devices and/or platforms (e.g., VR headsets, AR glasses, mobile devices, web browsers, etc.) that are capable of providing an MR environment. In addition, the export and deployment interface (1000) also includes a “project settings” section comprising “collaboration options” and “version control”, which may be useful metadata for potential future third-party updates to or partnerships with an MR content currently subject to exporting.

FIG. 11 is a use case diagram (1100) depicting various applications of the novel visual programming system in different domains such as education, smart homes, and interactive art installations, in accordance with an embodiment of the invention. As illustrated by the use case diagram (1100) in FIG. 11, a mixed-reality (MR) experience designer (i.e., an MR content creator) can utilize the novel visual programming system in this particular use case example to create educational content, design smart home interactions, or develop interactive art installations in an MR environment, which encompasses the MR experience designer-directed placements of real and virtual objects and interaction possibility designs among those real and virtual objects and prospective MR users.

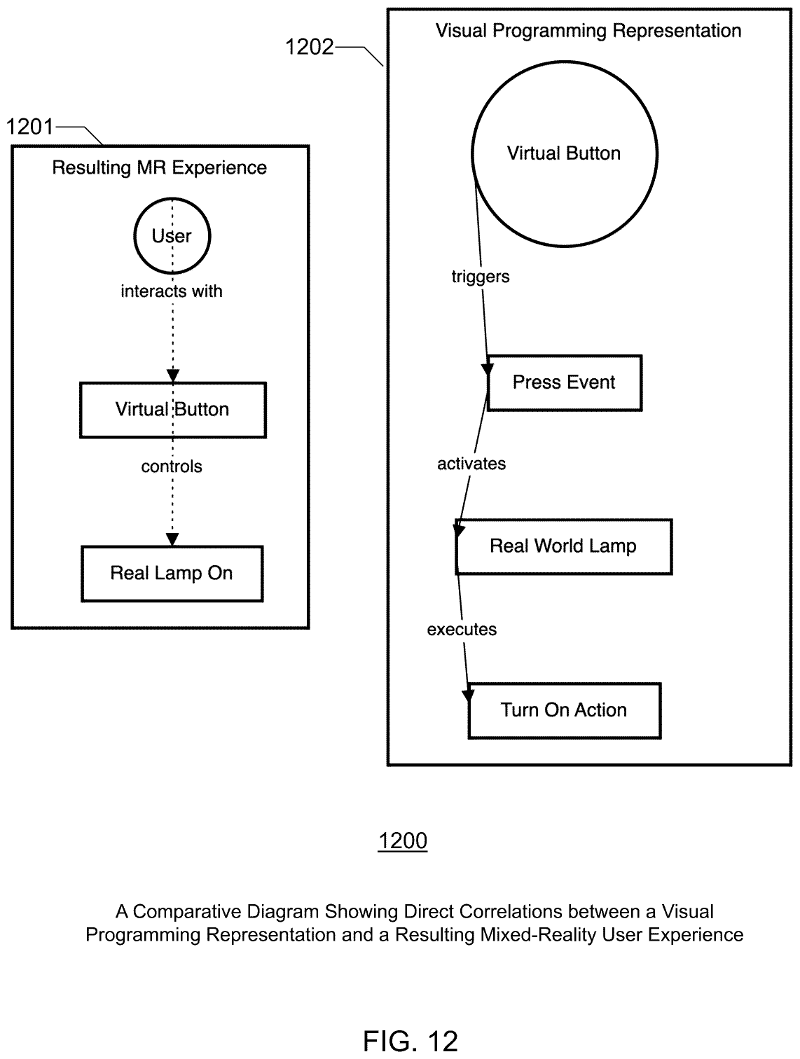

FIG. 12 shows a comparative diagram (1200) illustrating direct correlations between a visual programming representation (1202) and a resulting mixed-reality (MR) user experience (1201) for a complex MR interaction, in accordance with an embodiment of the invention. The novel visual programming system allows content creators to conduct visualized interaction authoring, in which an elaborate sequence of interactions can be created simply by connecting nodes representing virtual and real elements. For example, an MR content creator can connect a virtual button to a real physical lamp via a “turn on” action node, link a real object's position to a virtual object's scale, or use a physical slider to control a virtual particle system's emission rate.

Furthermore, the MR content creator can define elaborate behaviors and responses of any real or virtual objects that are positioned inside an MR environment through the node-based visual programming interface executed by the novel visual programming system. In particular, complex behaviors can be defined using combinations of nodes and connections. For instance, by manipulating (e.g., connect, disconnect, rewire, etc.) and controlling the node-based visual programming interface, the MR content creator can create a virtual thermostat that adjusts a physical HVAC (i.e., heating, ventilation, and air conditioning) system, design an interactive art installation that responds to mixed-reality viewers'movements, or develop a mixed-reality game in which virtual holographic characters interact with real-world physical objects. In the preferred embodiment of the invention, the visual programming system provides a library of common behaviors and responses that the content creator can quickly implement and customize through the node-based 3D visual programming interface, while not necessitating software coding knowledge throughout the entire MR content development process.

In context of the visual programming representation (1202) in FIG. 12, an MR content creator can choose a virtual button to connect to an event node, “press event,” which is triggered when a prospective MR user presses the virtual button. In the example as shown in FIG. 12, pressing the virtual button activates a real-world physical lamp in an MR environment. The MR content creator can also connect the real-world physical lamp to an action node, “turn on action,” in the node-based 3D visual programming interface to ensure that the physical lamp is turned on as an end result, if the prospective MR user presses the virtual button while being immersed in the MR environment. From the prospective MR user's perspective, the resulting MR experience (1201) is straightforward and intuitive: the MR user interacts with the virtual button by pressing it, and the physical lamp in the MR environment is turned on, as shown in the comparative diagram (1200) in FIG. 12.

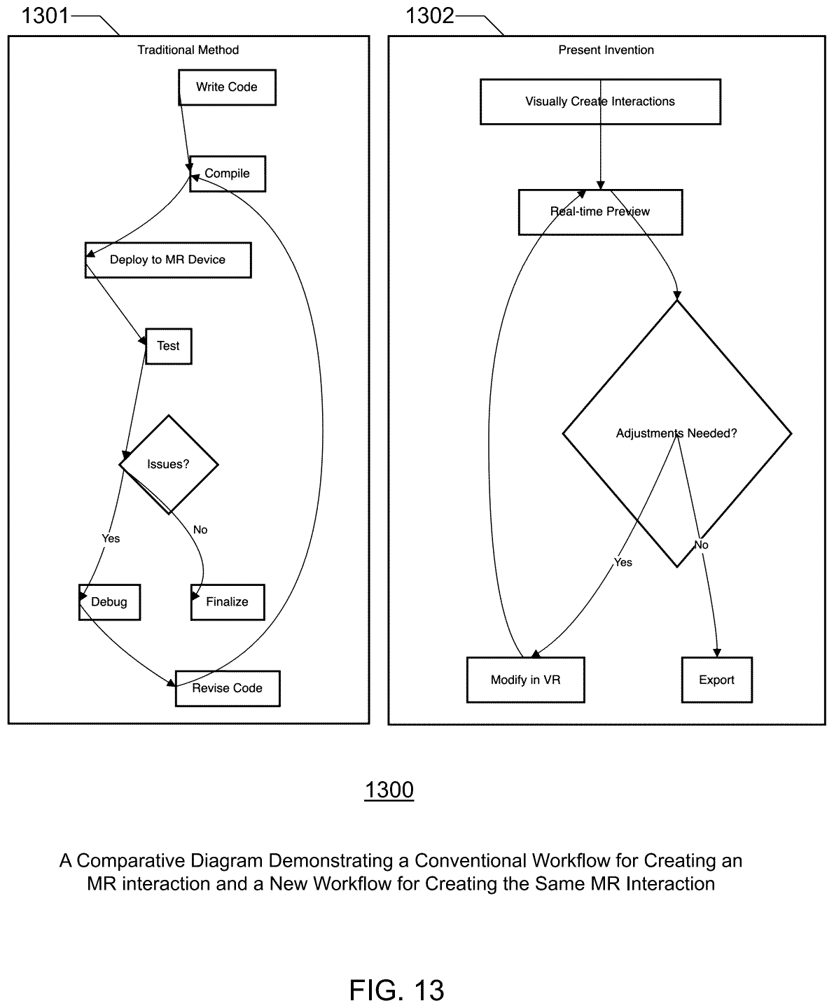

FIG. 13 shows a comparative diagram (1300) demonstrating a conventional workflow (1301) for creating an MR interaction and a new workflow (1302) for creating the same MR interaction using the novel visual programming system as embodied in the present invention. The conventional workflow (1301) entails a traditional software coding method, in which a content creator is a software engineer who first writes codes, which are compiled by a compiler of a programming tool. The compiled codes are then deployed to one or more mixed-reality (MR) devices and become executable by such devices. Each instance of the compiled codes may need to be tested by each device that received the compiled codes. If there are any problems or issues with the compiled codes, then the software engineer may need to debug and revise the written codes and then re-compile the debugged and revised codes to re-execute them in the deployed MR devices. Finally, if there are no more problems or issues with the re-compiled codes, then the conventional workflow (1301) for creating an MR interaction content is complete.

In contrast, the new workflow (1302) for creating the same MR interaction using the novel visual programming system, as embodied in the present invention, involves visually-creating interactions among prospective MR users, virtual objects, and real objects by selecting, using, and controlling the spatial anchoring method (e.g., FIG. 5), the abstracted components from the abstraction user interface (e.g., FIG. 7), and the node connections (e.g., FIG. 2, FIG. 4, FIG. 12, FIG. 14) among various objects from the visual programming interface, after the novel visual programming system completes the real object recognition and integration process upon scanning an MR environment to create real object nodes (e.g., FIG. 3) for the content creator to utilize during an MR interaction design and composition process.

In the new workflow (1302), there is no need for software coding by the content creator because all interaction and content compositions are completed visually and graphically through the visual programming interface provided by the novel visual programming system. The visualized MR interaction design and content composition process, which makes software coding knowledge unnecessary, lowers the barrier of entry for potential content creator base for mixed-reality experience designs and content creations, and serves as a significant advantage over the conventional workflow (1301) for MR content creations.

Furthermore, as also illustrated in the new workflow (1302) in FIG. 13, the novel visual programming system provides the real-time preview and debugging interface, which was previously demonstrated, for example, in FIG. 8 and corresponding descriptions. With the real-time preview and debugging interface, the content creator can readily edit, revise, and debug the visually-created MR interaction designs and contents, and if necessary, further modify such designs and contents through the 3D visualization programming interface. Once all adjustment and revisions are completed, the content creator can then command the visual programming system to execute an export function to transmit and deploy the created MR interaction designs and contents to a targeted MR device, as shown in the new workflow (1302) in FIG. 13.

FIG. 14 shows object recognition capabilities (1400) of the novel visual programming system as embodied in the present invention, which is configured to seamlessly identify and integrate various real-world (i.e., physical) objects into the visual programming environment of the novel visual programming system. As illustrated in FIG. 14, a physical table in the real-world environment is recognized as a “table node” in the programming environment by the object recognition module (i.e., 102 in FIG. 1). Similarly, a physical lamp and a physical chair are each recognized as a “lamp node” and a “chair node” in the programming environment, respectively, by the object recognition module (i.e., 102 in FIG. 1) executed by the novel visual programming system.

FIG. 15 shows a user interaction diagram (1500) to demonstrate how users (i.e., content creators) can manipulate (e.g., connect, disconnect, rewire, etc.) and connect virtual and real elements within the visual programming interface of the novel visual programming system. As illustrated in the user interaction diagram (1500), a content creator can utilize the 3D visual programming interface of the novel visual programming system to manipulate, select, and control positions and features of virtual and/or real objects, each of which are represented by nodes of various types. For example, the content creator can connect a virtual object or a real object to an action node to synthesize an interaction among objects and/or prospective MR users, as shown in FIG. 15.

The novel visual programming system for authoring mixed-reality interactions among various virtual and real objects and prospective MR users provide several key advantageous over existing MR creation tools. For example, the novel visual programming system provides an intuitive integration in which virtual and real-world elements are seamlessly connected within a unified visual programming interface. In addition, the novel visual programming system lowers the barrier to entry for MR content development and enables non-programmers to readily create complex MR interactions, even if they are not trained software engineers.

Furthermore, the novel visual programming system can provide a real-time feedback, such as an immediate and in-situ visualization of programmed interactions within the MR environment, which reduces efforts and development time for MR content creations. Moreover, the novel visual programming system offers abstraction of objects and corresponding reusability across multiple MR content development projects, which further reduces efforts and development time for incorporating complex interaction components within an MR content.

In addition, the novel visual programming system provides a safety-first approach to prospective MR users by incorporating built-in safety protocols for interactions involving real-world objects. Furthermore, the spatial interface of the novel visual programming system utilizes the three-dimensional (3D) depth-perception for a more intuitive programming experience. The novel visual programming system also integrates real-time dynamic object recognition capabilities in an MR content development and programming environment, and makes real-time integration of physical objects possible during an MR content development.

Various embodiments of the present invention for composing mixed-reality interactions and related methods of operating the invention described herein provide significant advantages over conventional mixed-reality content creation tools. For example, an embodiment of the present invention provides a novel visual programming system for composing and choreographing mixed-reality (MR) interactions between virtual elements and real (i.e., physical) objects, wherein the novel visual programming system does not require technical software coding knowledge or expertise for an MR content creator. Removing the software coding knowledge requirement in MR content creations lowers the barrier of entry to prospective MR content creators and may contribute to a more democratized and robust content creator base for MR applications and contents development.

Moreover, the novel visual programming system, implemented in accordance with an embodiment of the present invention, provides a visually-intuitive integration between virtual and real elements for incorporating seamless interactions between the virtual and real elements during an MR content synthesis, instead of treating such elements separately, as in the case with existing legacy AR/VR programming tools.

Furthermore, the novel visual programming system, implemented in accordance with an embodiment of the present invention, empowers a mixed-reality (MR) content creator to integrate robust and proactive user safety protocols, at the interaction design stage of an MR content, to prevent accidents or potentially-harmful interactions between a user immersed in the MR content and a physical object incorporated in the MR content.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims.

What is claimed is:

1. A visual programming system for composing mixed-reality (MR) interactions between real objects and virtual objects and integrating a user safety protocol against harmful interactions, the visual programming system comprising:
a head-mounted display device integrating a camera or another portable electronic device integrating the camera, wherein the head-mounted display device or the another portable electronic device is configured to communicate multimedia information with other parts of the visual programming system;
an object recognition module configured to scan, identify, and track a real physical object in a physical space, which is intended to be utilized as a mixed-reality (MR) environment, wherein the object recognition module is able to scan the real physical object via the multimedia information captured and transmitted by the camera integrated in the head-mounted display device or the another portable electronic device;
a visual programming core configured to generate a visual programming interface that represents the real physical object scanned by the object recognition module as a new real object node, and the real objects and the virtual objects already present in the MR environment as interconnectable nodes, wherein the new real object node and the interconnectable nodes are manipulated and controlled by a mixed-reality (MR) content creator to compose the MR interactions among various real and virtual objects and prospective users of the MR environment;
an event and signal processing engine configured to manage dataflows and events among the new real object node and the interconnectable nodes;
a spatial mapping and anchoring system configured to map the physical space to generate the mixed-reality (MR) environment and tie the various real and virtual objects together to the MR environment in a singular and unified coordinate system;
a safety protocol engine configured to empower the MR content creator to synthesize the user safety protocol that defines interactive limits and boundaries in the MR interactions between the prospective users and the real physical object to prevent user injuries or other harmful interactions when the prospective users are immersed in the MR environment; and
a memory unit and at least one of a central processing unit (CPU), an application processing unit (APU), and a graphical processing unit (GPU) of a computer server or another computing device executing the object recognition module, the visual programming core, the event and signal processing engine, the spatial mapping and anchoring system, and the safety protocol engine, wherein the computer server or the another computing device is also operatively connected to the head-mounted display device integrating the camera or the another portable electronic device integrating the camera for data communication.

2. The visual programming system of claim 1, further comprising a user interface renderer configured to generate three-dimensional (3D) user interface elements that are visible to the MR content creator or the prospective users in the MR environment executing the MR interactions.

3. The visual programming system of claim 1, further comprising a data storage and management unit configured to save, load, and manage the MR interactions and other collections of mixed-reality (MR) experiences composed by the MR content creator via the visual programming interface.

4. The visual programming system of claim 1, wherein the visual programming interface is rendered in three dimensions within the MR environment.

5. The visual programming system of claim 1, further comprising abstracted components generated through an abstraction user interface from the visual programming core, wherein the abstracted components are groupings of complex MR interactions packaged as drag-and-droppable reusable modular software components, which are configured to be utilized by the MR content creator in multiple MR content creation activities.

6. The visual programming system of claim 1, wherein the user safety protocol, which defines the interactive limits and the boundaries in the MR interactions between the prospective users and the real physical object, includes blocking a potential interaction with the real physical object or displaying a safety warning to the prospective users while being immersed in the MR environment.
